(19) United States
(12) Patent Application Publication
(10) Pub. No.: US 2004/0022713 A1
(43) Pub. Date: Feb. 5, 2004

(54) Method for producing trichlorosilane

(76) Inventors: Andreas Bulan, Langenfeld (DE); Rainer Weber, Odenthal (DE); Leslaw Mleczko, Bochum (DE)

Correspondence Address: MCGLEW & TUTTLE, PC, SCARBOROUGH STATION, SCARBOROUGH, NY, 10510, US

(21) Appl. No.: 10/380,320

(22) PCT Filed: Sep. 7, 2001
(86) PCT No.: PCT/EP01/10360

(30) Foreign Application Priority Data
Sep. 14, 2000 (DE) 100 45 367.8

(51) Int. Cl. C01B 33/107

(52) U.S. Cl. 423/342; 423/347

(57) ABSTRACT

The invention relates to a method for producing trichlorosilane by reacting silicon with hydrogen, silicon tetrachloride and optionally, hydrogen chloride in the presence of a catalyst, this catalyst having an average grain size that is less than the average grain size of the silicon used by a factor of 30 to 100.

The present invention relates to a method for producing trichlorosilane by reacting silicon with silicon tetrachloride, hydrogen and, if necessary, hydrogen chloride in the presence of a catalyst with a small grain diameter.

Trichlorosilane HSiCl₃ is a valuable intermediate product for producing, for example, high-purity silicon, dichlorosilane H₂SiCl₂, silane SiH₄ and bonding agents.

High-purity silicon is used versatilely for electronic and photo-voltaic purposes, e.g. in manufacturing solar cells. To produce high-purity silicon, for example, metallurgical silicon is converted to gaseous silicon compounds, preferably trichlorosilane, these compounds being purified and subsequently reconverted to silicon.

Trichlorosilane is mainly produced by reacting silicon with hydrogen chloride, or silicon with silicon tetrachloride, hydrogen and, if necessary, hydrogen chloride (Ullmann's Encyclopedia of Industrial Chemistry, 5^{th} ed. (1993), Vol. A24, 4-6). As a rule, silicon is reacted with silicon tetrachloride and hydrogen in the presence of catalysts, and mainly copper catalysts. The use of trichlorosilane for obtaining hyper-pure silicon is known from U.S. Pat. No. 4 676 967 A.

As is known from DE 41 04 422 A1, silicon is reacted with silicon tetrachloride and hydrogen in a fluidized bed without using pressure in the presence of copper salts of a low, aliphatic, saturated dicarbon acid, particularly copper oxalate.

It is also known to react silicon with silicon tetrachloride, hydrogen and, if necessary, hydrogen chloride, in the presence of powder copper (Chemical Abstracts CA 101, no. 9576d, 1984) or mixtures of copper metal, metal halogenides and bromides or iodides of iron, aluminum or vanadium (Chemical Abstracts CA 109, no. 57621 b, 1988).

From U.S. Pat. No. 4,504,597 a copper catalyst is known to be produced by high-energy milling of cupriferous particles with an average diameter of particles >15 μm in a Palla mill. According to U.S. Pat. No. 4,504,597 this catalyst is suitable as catalyst for reacting silicon with alkyl and/or aryl halides to alkyl and/or aryl halosilanes. The catalyst consists mainly of Cu₂O, CuO, Cu and, if necessary, promoters and has an average particle size after milling of essentially not more than 15 μm. Any use of this catalyst in a method for producing trichlorosilane is not mentioned.

Trichlorosilane is usually produced in a fluidized bed (Ullmann's Encyclopedia of Industrial Chemistry, 5^{th} ed. (1993), Vol. A24, 4-6). However, small particles are carried out of the fluidized bed by the flow of gas. Using a catalyst with a particularly small particle size does not seem to be reasonable, therefore, as small particles would be carried away immediately.

DE 196 54 154 A1 teaches a method for the production of trichlorosilane by reacting silicon with hydrogen and silicon tetrachloride in the presence of a catalyst. By way of comparison, such a reaction is also carried out, using silicon particles of an average particle diameter of 150 μm and copper powder of an average particle size of approximately 5 μm. With this grain diameter ratio, the pressure drop of the fluidized bed was observed gradually to show abnormal fluctuations and the fluid condition was observed to become extremely bad. Upon inspection of the particles after opening of the reactor and cooling down, an agglomeration of copper powder and an agglomeration of silicon particles of metallurgical grade was found in the particles withdrawn. Moreover, the inside wall of a particle outlet pipe was observed to be partially clogged by solid products.

Surprisingly it was found that the reaction of silicon with silicon tetrachloride, hydrogen and, if necessary, hydrogen chloride to trichlorosilane is better catalyzed in the presence of a finely distributed catalyst with a small grain diameter than in the presence of a catalyst with a big grain diameter without observing any considerable amount of catalyst being carried away.

Subject-matter of the invention is therefore a method for producing trichlorosilane by reacting silicon with hydrogen, silicon tetrachloride and, if necessary, hydrogen chloride, in the presence of a catalyst, characterized in that the catalyst has an average grain diameter that is a factor 30 to 100 smaller than the average grain diameter of the silicon used.

Preferably the catalyst has an average grain diameter that is a factor 50 to 100, particularly preferred a factor 70 to 100 smaller than the average grain diameter of the silicon used.

The average grain diameter is calculated as the arithmetical mean of the values determined in a sieve analysis of catalyst and/or silicon. The principles of the sieve analysis are specified, for example, in “Ullmanns Encyclopädie der technischen Chemie, 4^{th} ed., Vol. 2, p. 30-31”.

It is particularly preferred to mix the catalyst homogenously with the silicon prior to the reaction. This can be achieved, for example, by intense mixing in a plough blade mixer or triaxial mixer or other mixing apparatus suitable to produce an intensive solid-solid mixture.

Mixing in a plough blade mixer is preferred.

Suitable catalysts to be used are, for example, copper catalysts and/or iron catalysts.

Suitable copper catalysts are, for example, copper, preferably in form of copper powder with a grain size below 100 μm, particularly preferred with an average grain diameter below 20 μm, or compounds of copper, preferably copper oxide containing copper with the oxidation number of 1 or copper halogenide, particularly preferred copper chloride, such as e.g. cuprous chloride.

Suitable iron catalysts are, for example, iron, preferably in the form of iron powder with a grain size below 100 μm, particularly preferred with an average grain diameter below 10 μm, or compounds of iron, preferably iron halogenides, particularly preferred iron chloride, in particular preferred ferrous chloride.

It is also possible to use mixtures of copper catalysts and/or iron catalysts with further catalytically active components. Such catalytically active components are, for example, metal halogenides, such as e.g. chlorides, bromides or iodides of aluminum, vanadium or antimony.

The silicon used can be principally any kind of silicon, however the use of metallurgical silicon is preferred. Preferably silicon with an average grain diameter of 10 to 1000 μm, particularly preferred of 100 to 600 μm, is used.

Before being reacted with silicon tetrachloride, hydrogen and, if necessary, hydrogen chloride, the mixture of silicon and catalyst can be pre-reacted, e.g. with hydrogen chloride, or hydrogen chloride and hydrogen.

To pre-react the mixture of silicon and catalyst, it can be brought into contact with hydrogen chloride and hydrogen with a mol ratio of 1:0 to 1:10, preferably 1:0.5, at temperatures between 250 to 500° C., preferably between 300 and 350° C. Preferably the mixture of silicon and catalyst is fluidized here.

Usually a mixture of silicon and catalyst is prepared, with a concentration between 0.5 to 10, preferably between 1 to 5 weight percent catalyst calculated as metal, the weight percent being based on to the total weight of the mixture. It is also possible, however, to use a mixture of silicon and catalyst with a higher catalyst concentration.

The method according to the invention can be carried out, for example, at a pressure of 1 to 40 bar (absolute), preferably of 20 to 35 bar.

The process is carried out, for example, at temperatures from 400 to 800° C., preferably from 450 to 600° C.

The selection of the reactor for the reaction according to the invention is not critical, provided that under the reaction conditions the reactor shows adequate stability and permits the contact of the starting materials. The process can be carried out, for example, in a fixed bed reactor, a rotary tubular kiln or a fluidized-bed reactor. It is preferred to carry out the reaction in a fluidized-bed reactor.

The mol ratio of hydrogen to silicon tetrachloride in the reaction according to the invention can be for example 0.25:1 to 4:1. A mol ratio of 0.6:1 to 2:1 is preferred.

During the reaction according to the invention hydrogen chloride can be added, and the amounts of hydrogen chloride can be varied over a wide range. Preferably an amount of hydrogen chloride is added such that a mol ratio of silicon tetrachloride to hydrogen chloride of 1:0 to 1:10, particularly preferred of 1:0.5 to 1:1, is obtained.

Preferably the method according to the invention is carried out in the presence of hydrogen chloride.

The trichlorosilane produced according to the method according to the invention can be used, for example, for the manufacture of silane and/or hyper-pure silicon.

Therefore the invention also relates to a method for producing silane and/or hyper-pure silicon on the basis of trichlorosilane obtained according to the method specified above.

Preferably the method according to the invention is integrated into a general method for producing silane and/or hyper-pure silicon.

Particularly preferred, the method according to the invention is integrated into a multistage general method for producing hyper-pure silicon, as specified for example in “Economics of Polysilicon Process, Osaka Titanium Co., DOE/JPL 1012122 (1985), 57-78” and comprising the following steps:

a) Production of trichlorosilane;

b) Disproportionation of trichlorosilane to yield silane;

c) Purifying silane to obtain high-purity silane; and

d) Thermal decomposition of silane in a fluidized-bed reactor and depositing of hyper-pure silicon on the silicon particles which form the fluidized bed.

It is even more particularly preferred that the method according to the invention be integrated into a method for producing silane and/or hyper-pure silicon comprising the following steps:

1. Trichlorosilane synthesis according to the method according to the invention and subsequent isolation of the produced trichlorosilane by distillation and recycling of the unreacted silicon tetrachloride, and, if desired, the unreacted hydrogen;

2. Disproportionation of trichlorosilane to silane and silicon tetrachloride through the intermediate stage of dichlorosilane and monochlorosilane on basic catalysts, preferably catalysts containing amino groups, carried out in two apparatuses or in one, and recirculation of the produced silicon coming out as a high-boiling component into the first reaction area;

3. Further use of the silane of the purity given after the previous step, or purifying the silane until the purity required for the intended purpose is achieved, preferably by distillation, particularly preferred by distillation under pressure;

and, if necessary,

4. Thermal decomposition of silane to obtain high-purity silicon, usually above 500° C.

Apart from thermal decomposition on electrically heated high-purity silicon rods, another suitable method is the thermal decomposition in a fluidized bed consisting of hyper-pure silicon particles, particularly when the production of solar-grade high-purity silicon is desired. To this aim, silane can be mixed with hydrogen and/or inert gases at a mol ratio of 1:0 to 1:10.

1. A method for producing trichlorosilane by reacting silicon with hydrogen, silicon tetrachloride and, if necessary, hydrogen chloride, in the presence of a catalyst, characterized in that the catalyst has an average grain diameter that is a factor 50 to 100 smaller than the average grain diameter of the silicon used.

2. A method according to at least one of claims 1 to 2, characterized in that the silicon has an average grain diameter of 10 to 1000 μm.

3. A method according to at least one of claims 1 to 3, characterized in that the catalyst used is copper oxide.

4. A method according to at least one of claims 1 to 3, characterized in that the catalyst used is copper halogenide.

5. A method according to at least one of claims 1 to 3, characterized in that the catalyst used is iron powder and/or iron halogenide.

6. A method according to at least one of claims 1 to 6, characterized in that the concentration of catalyst in the mixture of silicon and catalyst, catalyst being calculated as metal, is between 0.5 to 10 weight percent catalyst based on the total weight of the mixture.

7. A method according to at least one of claims 1 to 7, characterized in that the reaction is carried out at a pressure of 1 to 40 bar (absolute).

8. A method according to at least one of claims 1 to 8, characterized in that the reaction is carried out at temperatures from 400 to 800° C.

9. A method according to at least one of claims 1 to 9, characterized in that the mol ratio of hydrogen to silicon tetrachloride is 0.25:1 to 4:1.

10. A method according to at least one of claims 1 to 10, characterized in that the mol ratio of silicon tetrachloride to hydrogen chloride is 1:0 to 1:10.

11. A method for producing silane and/or hyper-pure silicon, comprising the following steps:
reacting silicon with hydrogen, silicon tetrachloride and, if necessary, hydrogen chloride, in the presence of a catalyst which has an average grain diameter that is a factor 50 to 100 smaller than the average grain diameter of the silicon used;
producing the silane and/or the hyper-pure silicon, proceeding from the trichlorosilane produced by the reaction.
